(19) United States
(12) Patent Application Publication
(10) Pub. No.: US 2018/0142945 A1
(43) Pub. Date: May 24, 2018

(54) REFRIGERATOR WITH HINGED MULLION ASSEMBLY

(71) Applicant: WHIRLPOOL CORPORATION, BENTON HARBOR, MI (US)

(72) Inventors: Darryl C. Bodine, St. Joseph, MI (US); Eric A. Hill, Chicago, IL (US); Todd J. Tunzi, St. Joseph, MI (US)

(73) Assignee: WHIRLPOOL CORPORATION, BENTON HARBOR, MI (US)

(21) Appl. No.: 15/358,631

(22) Filed: Nov. 22, 2016

(51) Int. Cl. F25D 23/08; F25D 23/02; F25D 23/04; F25D 25/02; E05C 19/16; E05C 7/00; E05B 47/00

(52) U.S. Cl. CPC F25D 23/087; F25D 23/028; F25D 23/04; F25D 2400/04; E05C 19/161; E05C 7/005; E05B 47/0002; F25D 25/025

(57) ABSTRACT

A refrigerator includes a main body with first and second doors rotatably mounted to the main body. The second door is positioned below the first door with a gap disposed therebetween. A mullion assembly includes a mullion member rotatably mounted to the main body at an independent hinge assembly disposed adjacent to the gap between the first and second doors. The mullion member is operable between open and closed positions and is releasably coupled to a lower edge of the first door and an upper edge of the second door when the first and second doors are in the closed position. The first and second doors cooperate to provide access to a compartment while the mullion assembly provides a hinged sealing surface for the first and second doors at an intermediate height disposed along a length of the compartment.

### BACKGROUND

The present device generally relates to a mullion assembly for a refrigerator, and more particularly, to a mullion assembly that is disposed between upper and lower doors on a main body of a refrigerator, wherein the upper and lower doors and the mullion assembly are independently hinged to a common upright of the main body.

When a refrigerator design uses multiple stacked doors, a horizontal fixed mullion assembly is generally positioned in the horizontal area between the upper and lower doors. This arrangement serves to provide a seal for the doors when the doors are in a closed position, but introduces a fixed barrier to full access of the compartment to which the multiple stacked doors selectively provide access. Thus, a solution is desired, wherein multiple stacked doors provide access to a barrier free compartment, yet are fully sealed when the doors are in the closed position.

### SUMMARY

One aspect of the present concept includes a refrigerator including a main body with first and second doors rotatably mounted to the main body between open and closed positions. The second door is positioned below the first door with a gap disposed therebetween. A mullion assembly includes a mullion member rotatably mounted to the main body at an independent hinge assembly disposed adjacent to the gap between the first and second doors. The mullion member is operable between open and closed positions and is releasably coupled to a lower edge of the first door and an upper edge of the second door when the first and second doors are in the closed position.

Another aspect of the present concept includes a refrigerator having at least one compartment defined within a main body of the refrigerator and a front sealing surface disposed around a perimeter thereof. A first door is rotatably mounted to the main body between open and closed positions. A second door is rotatably mounted to the main body and is positioned vertically below the first door. The second door is operable between open and closed positions. A mullion assembly includes a mullion member rotatably mounted to the main body, wherein the mullion assembly is positioned vertically between the first and second doors. The mullion member is operable between open and closed positions.

Yet another aspect of the present concept includes a refrigerator having at least one compartment defined within a main body of the refrigerator. A first door is rotatably mounted to the main body and operable between open and closed positions. A second door is rotatably mounted to the main body and operable between open and closed positions. The second door is positioned vertically below the first door. A mullion assembly includes a mullion member that is rotatably mounted to the main body and positioned vertically at a gap disposed between the first and second doors. The mullion member is operable between open and closed positions.

These and other features, advantages, and objects of the present device will be further understood and appreciated by those skilled in the art upon studying the following specification, claims, and appended drawings.

### BRIEF DESCRIPTION OF THE DRAWINGS

In the drawings:

FIG. 1 is a top perspective view of a refrigerator configured for use with the present concept;

FIG. 2A is a perspective view of a refrigerator of a prior art configuration having multiple doors;

FIG. 2B is a perspective view of a refrigerator according to one embodiment of the present concept having multiple doors and multiple hinged mullion assemblies;

FIG. 2C is a perspective view of a refrigerator according to another embodiment of the present concept having multiple doors and a single hinged mullion assembly;

FIG. 3A is a top perspective view of the refrigerator of FIG. 1 having a right upper door in an open position;

FIG. 3B is a fragmentary top perspective view of the refrigerator of FIG. 3A with the right upper door removed therefrom to reveal a hinged mullion assembly;

FIG. 4 is a front perspective view of the refrigerator of FIG. 1 having upper and lower right hand doors in open positions with a hinged mullion assembly in an open position;

FIG. 5 is a front perspective view of the refrigerator assembly of FIG. 3A;

FIG. 6 is a front perspective view of the refrigerator assembly of FIG. 1 with the lower right hand door in an open position;

FIG. 7A is a front perspective view of the refrigerator assembly of FIG. 4 with the upper and lower right hand doors in open positions with the hinged mullion assembly coupled to the lower door;

FIG. 7B is a front perspective view of the refrigerator assembly of FIG. 7A with the hinged mullion assembly coupled to the upper door;

FIG. 8 is a fragmentary cross-sectional view of the upper and lower refrigerator doors and hinged mullion assembly of FIG. 2B taken at line VIII;

FIG. 9A is a fragmentary front perspective view of a refrigerator having a hinged mullion assembly according to another embodiment; and

FIG. 9B is a front perspective view of a refrigerator having a hinged mullion assembly according to another embodiment.

### DETAILED DESCRIPTION OF EMBODIMENTS

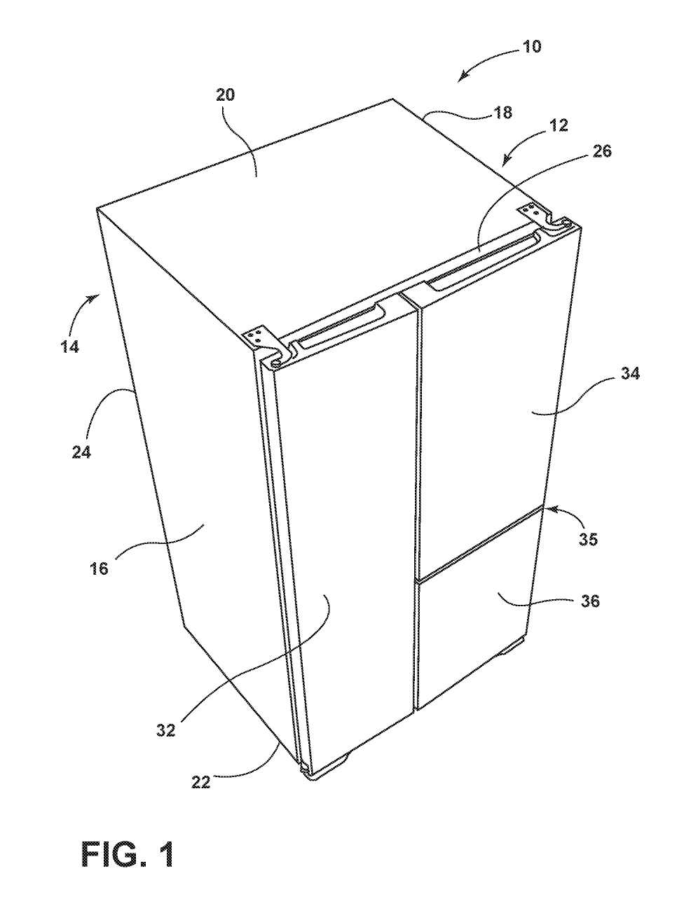

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

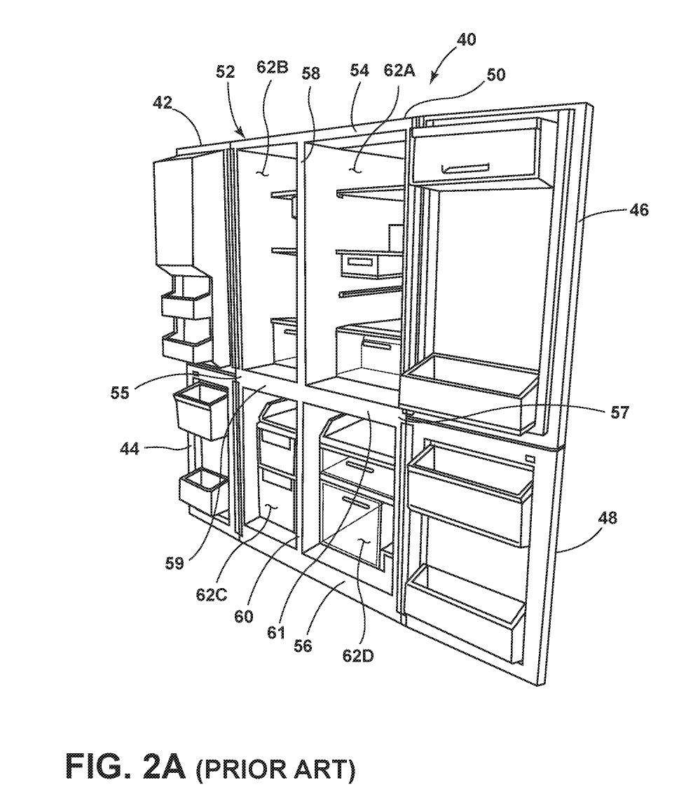

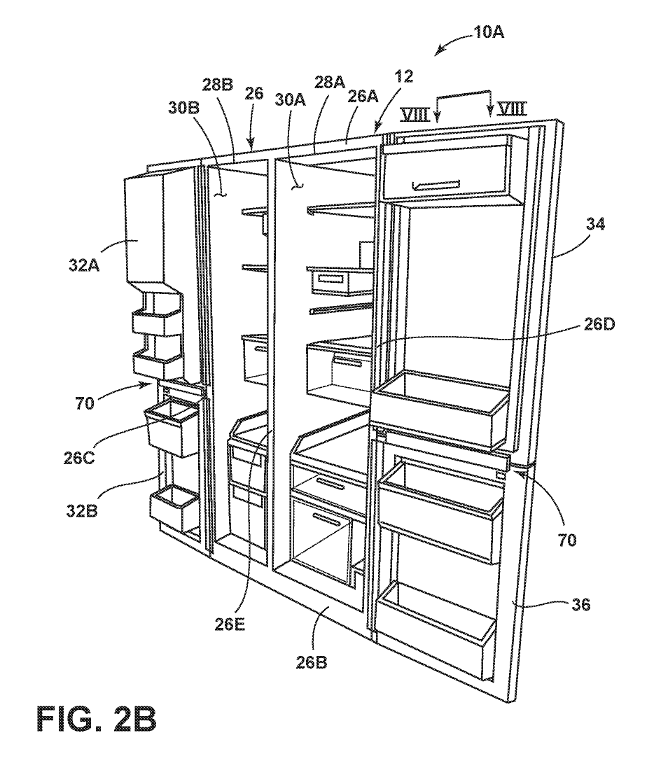

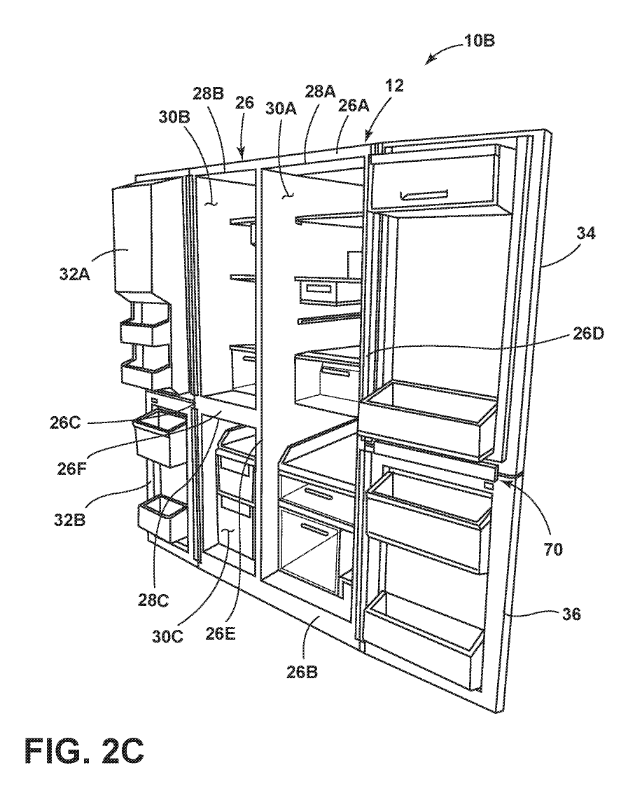

Referring now to FIG. 1, a refrigerator 10 is shown having a main body 12 which is generally defined by an exterior wrapper 14. The exterior wrapper 14 includes first and second sides 16, 18, upper and lower sides 20, 22, and a rear side 24. The exterior wrapper 14 is generally configured to receive one or more liners therein for providing different compartments within the refrigerator 10. The main body 12 includes a front sealing surface 26 having multiple openings which open into interior compartments of the refrigerator 10. For example, the main body may include multiple openings much like openings 28A-28C shown in FIG. 2C, which open into interior compartments 30A-30C as shown in FIG. 2C. The front sealing surface 26 may include parts of the exterior wrapper 14 and/or parts of a liner and/or parts of a thermal bridge. Regardless of the components parts, the front sealing surface 26 is a front fascia of the main body 12 providing a sealing surface for the refrigerator doors. The refrigerator 10, as shown in FIG. 1, includes a plurality of doors which are rotatably mounted to the main body 12 of the refrigerator 10. In the embodiment shown in FIG. 1, the plurality of doors includes a left hand door 32, an upper right hand door 34 and a lower right hand door 36. The doors 32, 34 and 36 are rotatably mounted to the main body 12 for selectively providing access to the compartments of the refrigerator 10. Thus, the doors 32, 34 and 36 are operable between open and closed positions and are shown in FIG. 1 in closed positions. The doors 32, 34 and 36 operate along swing paths defined between a closed position and an open position and various intermediate open positions therebetween, as further described below. The upper right hand door 34 and lower right hand door 36 are shown in a vertically stacked configuration with door 36 positioned vertically below door 34. A gap 35 is disposed between the doors 34, 36. While the refrigerator 10 shown in FIG. 1 includes a door configuration having a single left hand door 32 and upper and lower right hand doors 34, 36, it is contemplated that the refrigerator 10 may include other door configurations for use with the present concept. Further, the refrigerator 10 may also include various compartment configurations, such that the present concept is not limited to any specific door or compartment configuration, but rather is shown in the figures of this disclosure in exemplary non-limiting embodiments only.

Referring now to FIG. 2A, a refrigerator 40 of a prior art configuration is shown having upper and lower left hand doors 42, 44 and upper and lower right hand doors 46, 48 coupled to a main body 50. The main body 50 includes a front sealing surface 52 having perimeter portions 54-57. Within the perimeter portions 54-57, fixed interior mullion structures 58-61 are disposed. The perimeter portions 54-57 cooperate with the interior mullion structures 58-61 to define compartments 62A-62D. The interior mullion structures 58, 60 generally define a horizontal division of the main body 50, while interior mullion structure 59, 61 provide for a horizontal division of the main body 50. In this configuration, the interior mullion structures 58-61 are fixed members which divide the main body 50 into the individual compartments 62A-62D in a fixed rigid manner, even though these compartments may share particular specifications. For instance, compartment 62A and 62D may both be refrigerator compartments which could benefit from increased spacing if the internal mullion structure 61 were removed therefrom. However, with internal mullion structure 61 removed between compartments 62A and 62D, the upper and lower right hand doors 46, 48 would not have a sealing surface to seal against for the lower and upper portions thereof, respectively.

Referring now to FIG. 2B, a refrigerator 10A is shown having similar components as refrigerator 10 shown in FIG. 1, for which like reference numerals are used to identify similar components thereof. The front sealing surface 26 of the main body 12 includes perimeter portions 26A-26D with a fixed interior mullion structure 26E vertically dividing the main body 12 into compartments 30A and 30B. Thus, the refrigerator 10A includes opening 28A opening into compartment 30A, and opening 28B opening into compartment 30B. The left hand door configuration includes upper and lower doors 32A, 32B having a hinged mullion assembly 70 disposed therebetween. The right hand door configuration includes upper and lower right hand doors 34, 36 having a hinged mullion assembly 70 disposed therebetween. Thus, the refrigerator 10A includes multiple hinged mullion assemblies 70 for providing sealing surfaces for upper and lower doors 32A, 32B and upper and lower doors 34, 36, respectively. With intermediate sealing surfaces provided by the hinged mullion assemblies 70, the compartments 30A, 30B are uninterrupted compartments spanning between the upper and lower perimeter portions 26A, 26B of the front sealing surface 26 of the main body 12. In this way, when the doors 32A, 32B, 34 and 36 are in the open position, as shown in FIG. 2B, the main body 12 is divided solely by the fixed interior mullion structure 26E which is vertically disposed between the first and second compartments 30A, 30B.

Referring now to FIG. 2C, another embodiment of a refrigerator 10B is shown having similar components as refrigerators 10 and 10A described above. Thus, like reference numerals will be used to describe similar features between the refrigerators 10, 10A and 10B. The front sealing surface 26 of the main body 12 includes perimeter portions 26A-26D with a fixed interior mullion structure 26E vertically dividing the main body 12 into compartments 30A, 30B and 30C. Thus, the refrigerator 10B includes opening 28A opening into compartment 30A, opening 28B opening into compartment 30B, and opening 28C opening into compartment 30C. The left hand door configuration includes upper and lower doors 32A, 32B having a fixed interior mullion structure 26F disposed therebetween. The right hand door configuration includes upper and lower right hand doors 34, 36 having a hinged mullion assembly 70 disposed therebetween. Thus, the refrigerator 10B includes a single hinged mullion assembly 70 for providing sealing surfaces for upper and lower doors 34, 36. With the intermediate sealing surface provided by the hinged mullion assembly 70, compartment 30A is an uninterrupted compartment spanning the vertical length between the upper and lower perimeter portions 26A, 26B of the front sealing surface 26 of the main body 12. In this way, when the doors 34 and 36 are in the open position, as shown in FIG. 2C, the main body 12 is divided solely by the fixed interior mullion structures 26E and 26F to provide compartments 30A-30C, with the right hand side compartment 30A being an uninterrupted compartment that is sealed closed using upper and lower doors 34, 36.

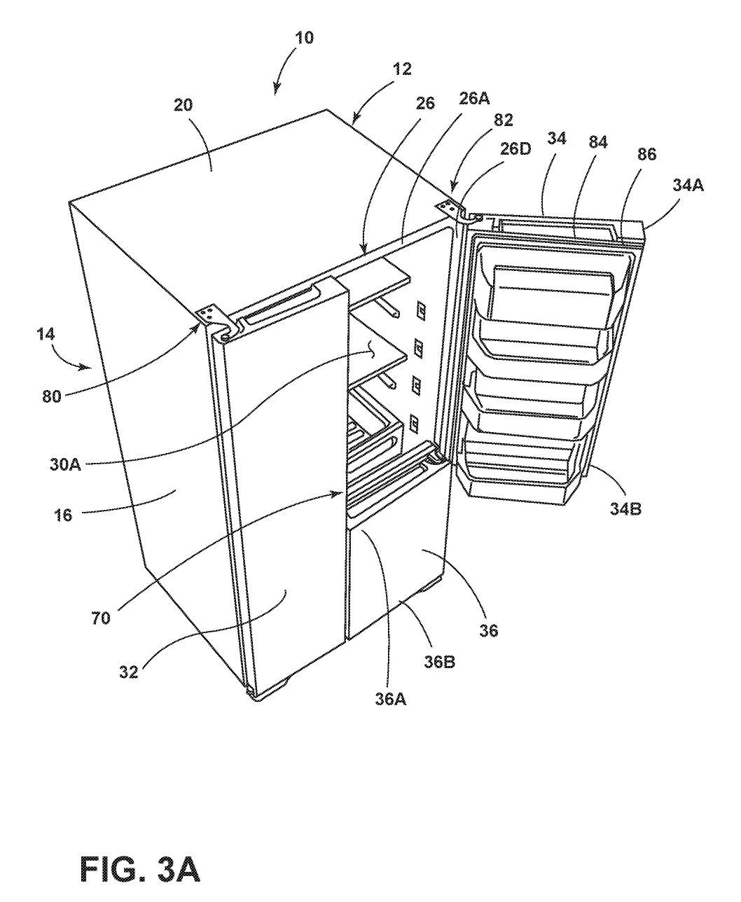

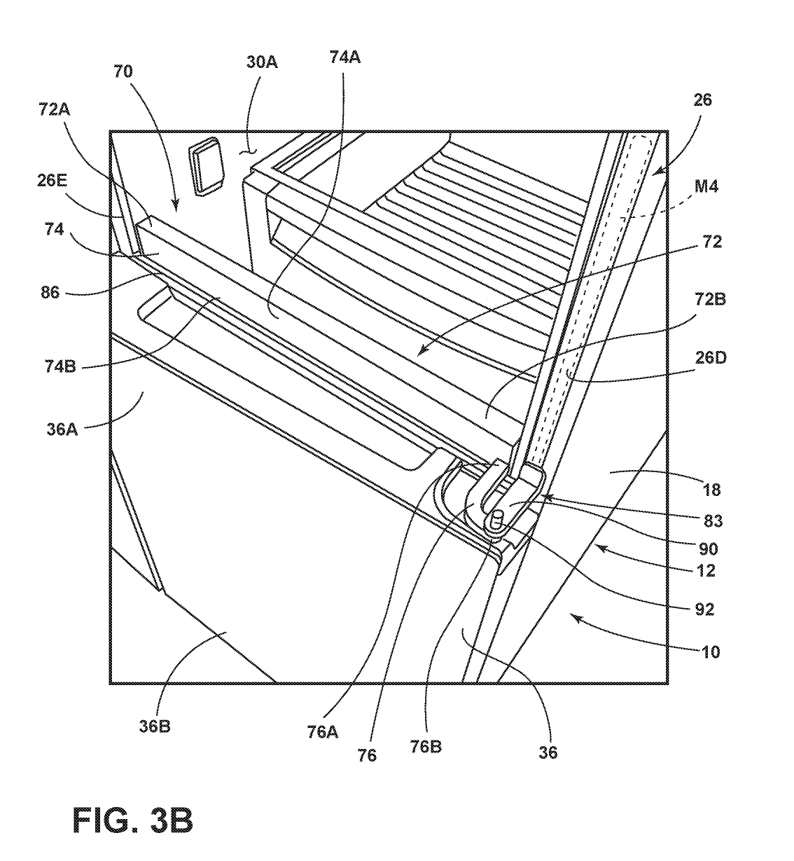

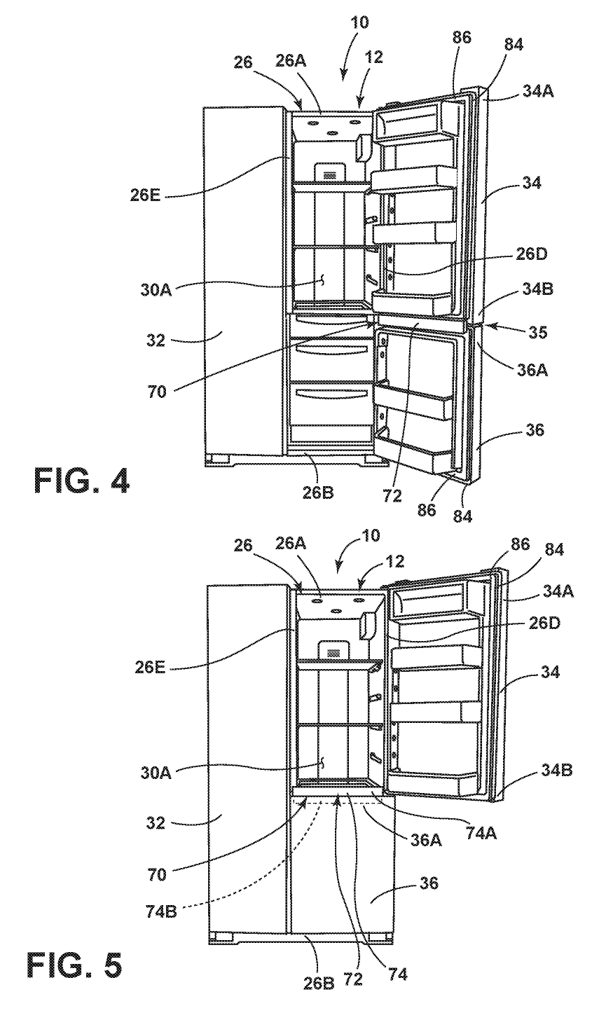

Referring now to FIG. 3A, the refrigerator 10 of FIG. 1 is shown having upper right hand door 34 in an open position to provide access to an upper portion of compartment 30A. Compartment 30A may be a refrigerator or freezer compartment depending on the specifications of the refrigerator 10. Lower right hand door 36 is shown in a closed position, thereby closing off access to a lower portion of compartment 30A. The mullion assembly 70 is shown positioned between the doors 34, 36 at a vertical position adjacent the gap 35 (FIG. 1) disposed between the doors 34, 36. The mullion assembly 70 is shown in a closed position in FIG. 3A, such that an upper portion 36A of door 36 is sealed against the mullion assembly 70 as further described below. In FIG. 3A, upper hinge assemblies 80, 82 are used to hingedly mount the doors 32, 34 to the main body 12 for rotating movement therefrom. Each door includes a sealing assembly disposed on an inner surface thereof, which is best exemplified in FIG. 3A with reference door 34. Door 34 includes an inner surface 84 which defines a perimeter around the door 34 on an inner side thereof. A sealing member or gasket 86 is disposed entirely around the inner surface 84. In use, the gasket 86 seals against the front sealing surface 26 of the main body 12. The front sealing surface 26 is disposed around a perimeter of compartment 30A with upper and lower sealing surfaces 26A, 26B (FIG. 4) and uprights 26D, 26E (FIG. 3B). The gasket 86 and the front sealing surface 26 may further include magnetic members in either structure (or both) to provide a magnetic coupling of the gasket 86 to the front sealing surface 26 when door 34 is in the closed position. As further shown in FIG. 3A, upper door 34 includes upper and lower portions 34A, 34B, and lower door 36 includes upper and lower portions 36A, 36B.

Referring now to FIG. 3B, the refrigerator 10 of FIG. 3A is again shown having the upper door 34 removed therefrom to provide a top perspective view of the mullion assembly 70. The mullion assembly 70 is shown in a closed position having a mullion member 72. The mullion member 72 is generally a rectangular member having first and second ends 72A, 72B which are disposed adjacent to uprights 26E, 26D of the front sealing surface 26 of the refrigerator 10 when the mullion member 72 is in the closed position. Thus, with the mullion assembly 70 in the closed position, the mullion member 72 generally spans a width of the compartment 30A between the spaced-apart uprights 26E, 26D to provide a horizontal divider for compartment 30A. The mullion member 72 further includes an outer sealing surface 74 having upper and lower portions 74A, 74B. The upper and lower portions 74A, 74B of the outer sealing surface 74 provide sealing locations for the upper and lower doors 34, 36. In FIG. 3B, a gasket 86 of door 36 is shown in a sealed relationship with the lower portion 74B of the mullion member 72, such that door 36 is provided a sealing surface in the outer sealing surface 74 of the mullion member 72 for the upper portion 36A thereof. Likewise, upper portion 74A of the mullion member 72 provides a sealing surface for door 34 when door 34 is in a closed position, such as shown in FIG. 1. The second end 72B of the mullion member 72 includes an attachment bracket 76 coupled thereto which outwardly extends from the outer sealing surface 74 at a first end 76A thereof. A second end 76B of the attachment bracket 76 is pivotally coupled to an intermediate hinge assembly 83 which is coupled to the main body 12 at upright 26D of the front sealing surface 26. The intermediate hinge assembly 83 includes an outwardly extending bracket 90 having a pivot shaft 92 disposed therethrough. The pivot shaft 92 is contemplated to be rotatably support upper door 34 and lower door 36, while also independently rotatably supporting the mullion member 72 between open and closed positions. As used herein, the term “independent” is meant to signify that the mullion assembly 70 pivots freely from intermediate hinge assembly 83, even though the movement of the mullion assembly 70 between open and closed positions can be predicated by the doors 34, 36. Movement of the mullion member 72 of the mullion assembly 70 will now be described with reference to FIGS. 4, 5 and 6.

Referring now to FIG. 4, the right hand upper and lower doors 34, 36 are shown in the open position with the mullion assembly 70 also shown in the open position. Specifically, the mullion member 72 of the mullion assembly 70 is shown coupled to a lower portion 34B of door 34, as well as an upper portion 36A of door 36. The mullion member 72 is contemplated to be releasably coupled to the gaskets 86 of the doors 34, 36 disposed along the inner surfaces 84 of the doors 34, 36. As shown in FIG. 4, the mullion member 72 is disposed at a height on the main body 12 that is adjacent to the gap 35 between the doors 34, 36. With both doors 34, 36 in the open position shown in FIG. 4, the compartment 30A is an uninterrupted compartment having no horizontal interior mullion structures disposed therein.

Referring now to FIG. 5, upper door 34 is shown in an open position, while lower door 36 is shown in a closed position. In this configuration, the mullion assembly 70 of the refrigerator 10 is shown in a closed position, wherein mullion member 72 spans the distance between uprights 26E, 26D to provide an outer sealing surface 74 for the doors 34, 36. Specifically, upper portion 36A of door 36 is shown in a sealed position against lower portion 74B of outer sealing surface 74 of the mullion member 72. The upper portion 74A of the outer sealing surface 74 of mullion member 72 is shown exposed and ready to seal against the lower portion 34B of door 34 at gasket 86 thereof.

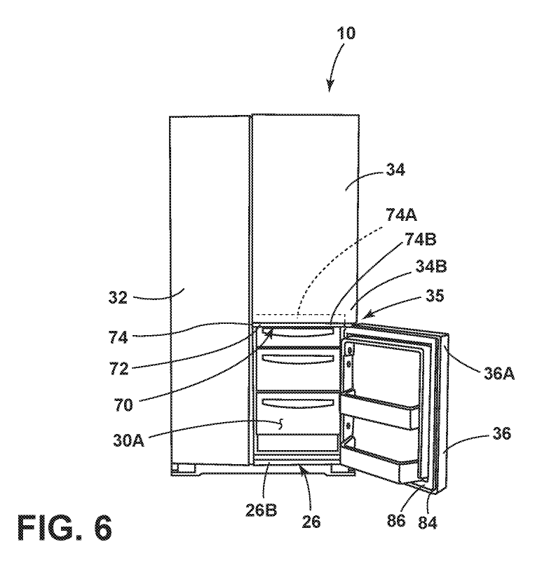

Referring now to FIG. 6, the mullion assembly 70 is again shown in a closed position, with upper door 34 also shown in a closed position. With the upper door 34 in the closed position, the lower portion 34B of the upper door 34 is releasably coupled to the upper portion 74A of the outer sealing surface 74 of the mullion member 72. The lower portion 74B of the mullion member 72 is exposed as lower door 36 is in an open position. With lower door 36 in an open position, access to a lower portion of the compartment 30A is provided. As lower door 36 moves to a closed position, the upper portion 36A of the door 36 will releasably couple to the exposed lower portion 74B of the outer sealing surface 74 of the mullion member 72 at gasket 86. Thus, in FIG. 4, the front sealing surface 26 of the main body is shown having fixed sealing structures 26A, 26B, 26D and 26E forming a perimeter around compartment 30A and for sealing against the gaskets 86 of the doors 34, 36 at perimeter portions thereof. The mullion assembly 70 provides the outer sealing surface 74 for sealing against the lower portion 34B of door 34 and the upper portion 36A of door 36 at the gap 35, to ensure that the entire compartment 30A is sealed when the doors 34, 36 are in the closed position as shown in FIG. 1. Thus, the front sealing surface 26 of the main body 12 and the outer sealing surface 74 of the mullion assembly 70 provide a complete front sealing surface for sealing compartment 30A using the doors 34, 36 at the gaskets 86 thereof.

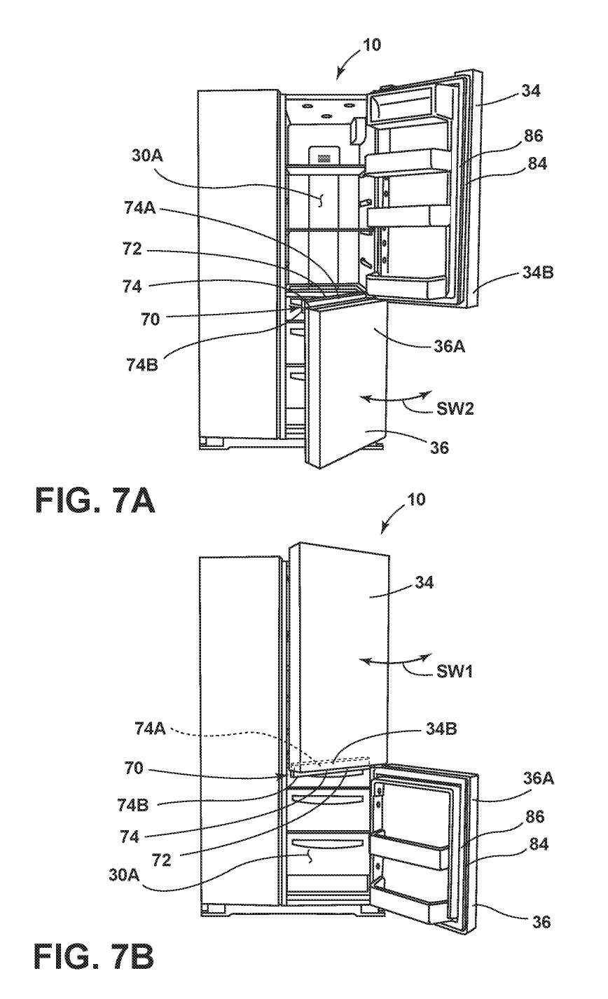

With the mullion assembly 70 being a freely hinged assembly, the mullion assembly may be coupled to one door or another based on a position of the doors along a particular swing path. With particular reference to FIG. 7A, upper door 34 is shown in an open position and lower door 36 is also shown in an open position. The mullion member 72 is shown coupled to an upper portion 36A of lower door 36 at lower portion 74B of the outer sealing surface 74 of the mullion member 72. When the mullion member 72 is coupled to the lower door 36, the mullion member 72 is configured to move with the door 36 along a swing path SW2 of the lower door 36 towards a fully open position. Similarly, with reference to FIG. 7B, the upper door 34 includes a swing path SW1 between open and closed positions. As the upper door 34 moves towards a closed position, the lower portion 34B will contact the mullion member 72 at the upper portion 74A of the outer sealing surface 74 thereof to intercept the mullion member 72. This interception of the mullion member 72 releases the lower portion 74B of the outer sealing surface 74 of the mullion member 72 from its releasably coupled position with the upper portion 36A of lower door 36 as upper door 34 continues towards a closed position along wing path SW1. At this interception, the lower portion 34B of the upper door 34 contacts and couples the upper portion 74A of the outer sealing surface 74 of the mullion member 72 to move the mullion member 72 towards the closed position. Thus, in use, the mullion member 72 will be coupled to either door 34, or door 36 depending on which door is closer to the closed position along the swing paths SW1, SW2, respectively, thereof. Thus, with the lower door 36 closer to the closed position as compared to upper door 34, the mullion member 72 is coupled to the upper portion 36A of lower door 36. With reference to FIG. 7B, the upper door 34 is closer to the closed position as compared to the lower door 36, such that the mullion member 72 is coupled to the lower portion 34B of the upper door 34. The abutment of the lower portion 34B of the upper door 34 or the upper portion 36A of the lower door 36 to the mullion member 72 creates a coupling to the mullion member 72 that breaks a previous coupling of the opposite door as one door moves closer to a closed position relative to the opposite door. In this way, it is contemplated that the mullion member 72 will remain in a coupled position with one of the doors 34 or 36 when a user is accessing compartment 30A of the refrigerator 10.

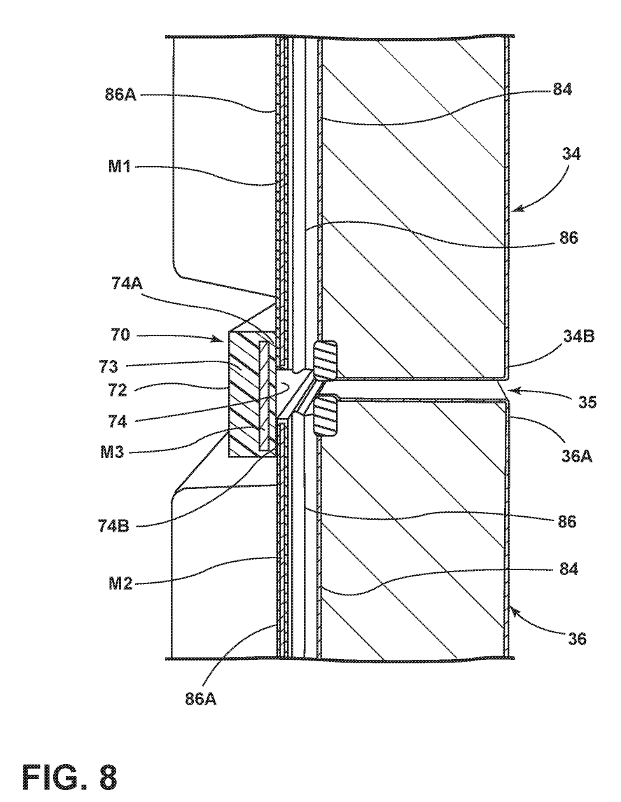

Referring now to FIG. 8, a cross-sectional view of the upper door 34 and lower door 36 is shown with the mullion member 72 coupled thereto. Specifically, the outer sealing surface 74 of the mullion member 72 is coupled to the gaskets 86 of the upper and lower doors 34, 36 at the lower portion 34B of upper door 34 and the upper portion 36A of the lower door 36. As shown in the cross-sectional view of FIG. 8, the gaskets 86 of the upper and lower doors 34, 36 includes an outer surface 86A which is used to seal against the outer sealing surface 74 of the mullion member 72. The outer surface 86A of the gaskets 86 is also used to seal against the front sealing surface 26 of the main body 12 of the refrigerator 10 described above. In an interior portion of the gaskets 86, magnetic members M1, M2 are disposed in the upper door 34 and lower door 36, respectively. The magnetic members M1, M2 are disposed adjacent to the outer surface 86A of the gaskets 86. The magnetic members M1, M2 are configured to magnetically couple to a reciprocal magnetic element disposed adjacent to the front sealing surface 26 of the refrigerator 10 within the main body thereof, as well as a magnetic member M3 disposed within an interior 73 of the mullion member 72. The magnetic member M3 may be a component part comprised of a metal material, a magnetizable material, or a permanent magnet. Similarly, the magnetic members M1, M2 of the doors 34, 36 may be a metallic material, a magnetizable material, or a permanent magnet. Regardless of the composition of the magnetic members M1-M3, it is contemplated that magnetic members M1, M2 are configured to provide a magnetic attraction to magnetic member M3, such that the doors 34, 36 magnetically couple to the mullion member 72 and seal against the outer sealing surface 74 thereof. In the embodiment shown in FIG. 8, the magnetic member M3 spans both the upper and lower portion 74A, 74B of the outer sealing surface 74 of the mullion member 72. However, it is contemplated that multiple magnetic members can be used to couple to the magnetic members M1, M2 of the doors 34, 36 within the interior portion 73 of the mullion member 72. As shown in FIG. 8, the mullion member 72 substantially covers the gap 35 between the upper door 34 and lower door 36 as coupled thereto. In this way, the doors 34, 36 can seal off the compartment 30A completely when the doors 34, 36 are in the closed position. The magnetic members M1, M2 are further contemplated to be disposed entirely around a periphery of the gaskets 86 adjacent the outer surface 86A thereof. In this way, the gaskets 86 can magnetically couple to the front sealing surface 26 of the refrigerator 10.

With reference to FIG. 3B, upright 26D of the sealing surface 26 is shown having a magnetic member M4 disposed thereon. The magnetic members M1, M2 are configured to seal against the magnetic member M4 to magnetically couple the doors 34, 36 to the main body 12 at the sealing surface 26 thereof. Magnetic member M4 may be a magnet material, or a metal part of the main body 12 of the refrigerator 10. It is further contemplated that when a user opens one of the doors 34, 36, the user will overcome the magnetic coupling between magnetic members M1 or M2 with magnetic member M4 disposed within the main body 12 of the refrigerator 10. When overcoming this coupling along the front sealing surface 26, the user's force of pulling one of the doors 34, 36 will also overcome the magnetic coupling between magnetic members M1 or M2 with magnetic member M3 disposed on the mullion member 72. In this way, each door can be opened independently with the mullion member 72 remaining in the closed position while an individual door alone is opened. When both doors 34, 36 are opened simultaneously, the mullion member 72 will remain coupled to the doors 34, 36 and move to the open position with the movement of the doors 34, 36 along the swing paths SW1, SW2 thereof.

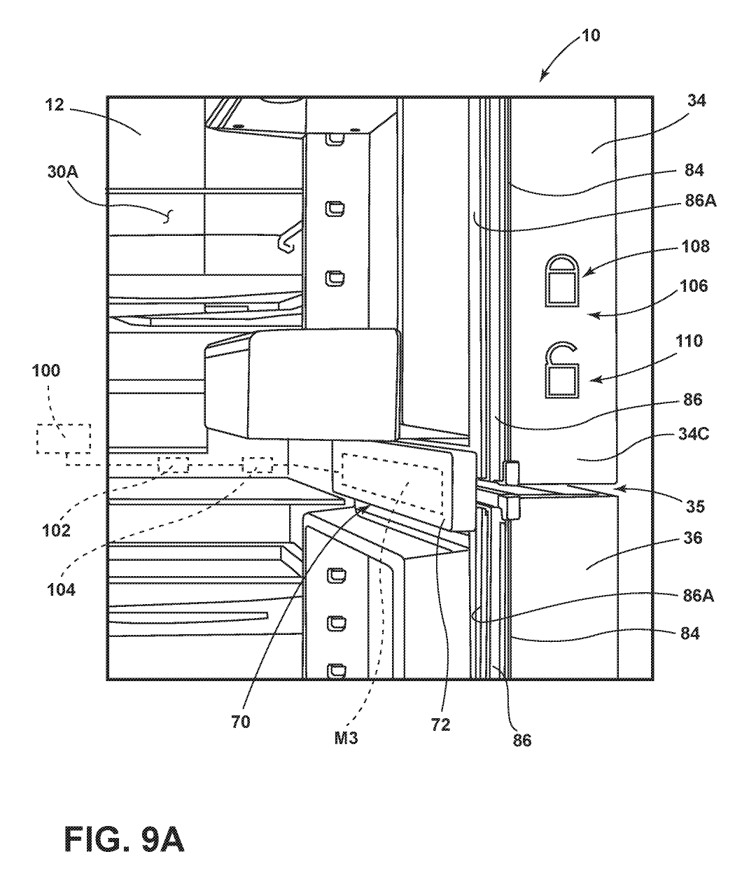

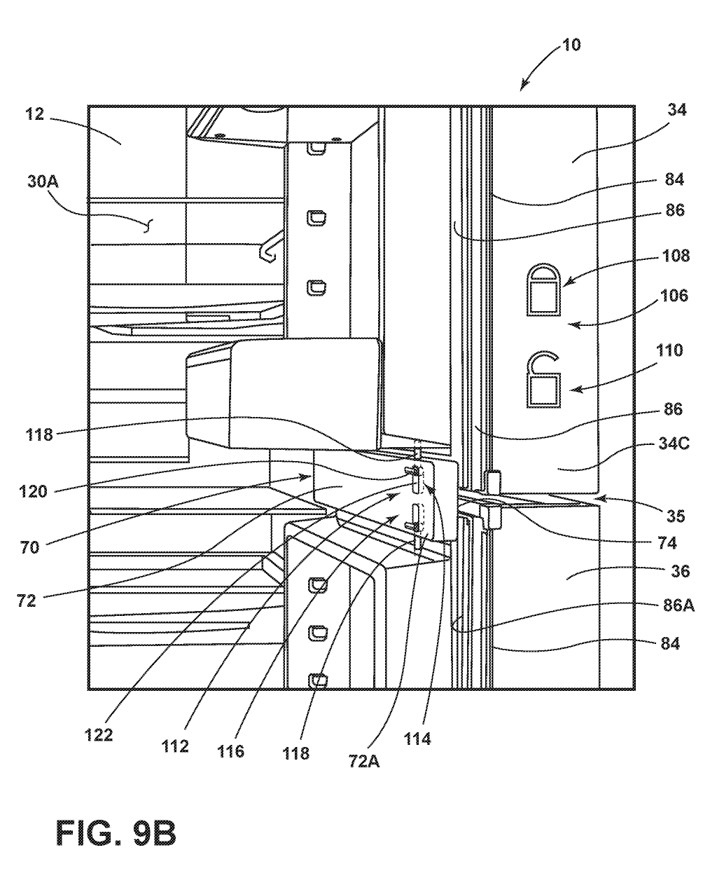

With reference now to FIG. 9A, a unifying feature of the refrigerator 10 will now be described. The unifying feature of the refrigerator 10 involves a coupling of the upper and lower doors 34, 36 to one another, such that the upper and lower doors 34, 36 move in unison when a user goes to open either door individually. It is contemplated that the mullion assembly 70 will move with the doors 34, 36 and remain coupled thereto using the unifying feature. In the embodiment shown in FIG. 9A, the refrigerator 10 is contemplated to include a user interface 100 that is electrically coupled to a power source 102 which is further coupled to a controller 104. The user interface 100 may be disposed anywhere on the refrigerator 10 including the main body 12 or any of the doors 32, 34 or 36. The user interface 100 will generally include a selection device or display from which a user can select a unifying option for the doors 34, 36. In the embodiment shown in FIG. 9A, it is contemplated that the user interface 100 will include a unifying feature selection, wherein magnetic member M3 includes an electromagnetic member that is energized by a current passing therethrough supplied from the controller 104. Thus, electromagnetic member M3 is operable between activated and inactivated conditions. When electromagnetic member M3 is in an activated condition, the magnetic attraction between magnetic members M1, M2 and electromagnet member M3 is stronger than the magnetic attraction between the magnetic members M1, M2 and the magnetic member M4 of the front sealing surface 26 of the main body 12. Thus, when electromagnetic member M3 is activated, the electromagnetic member M3 creates a magnetic flux providing a strong magnetic coupling to the upper and lower doors 34, 36 that remains intact as one of the doors 34 or 36 alone is pulled open by a user. Given this strong magnetic attraction between the mullion member 72 and the doors 34, 36, which ever door is pulled open, the reciprocal door will also open as interconnected to the opening door via the mullion member 72 of the mullion assembly 70. As further shown in FIG. 9A, the upper door 34 may include a side panel 34C having a digital display 106 disposed thereon. In the embodiment shown in FIG. 9A, the digital display 106 includes locked and unlocked indicia 108, 110 which may be illuminated indicia to indicate whether or not the upper and lower doors 34, 36 are in a unified condition as opposed to an independent opening condition. Thus, when the electromagnetic member M3 is activated using the user interface 100, it is contemplated that the locked indicia 108 will illuminate to indicate to the user that the doors 34, 36 are in the unified condition.

Referring now to FIG. 9B, the mullion assembly 70 is shown coupled to the upper and lower doors 34, 36 at the outer sealing surface 74 of the mullion member 72 and gaskets 86 of the upper and lower doors 34, 36. The mullion assembly 70 of the embodiment shown in FIG. 9B includes a unifying feature in the form of a mechanical locking mechanism 112. In the embodiment shown in FIG. 9B, the locking mechanism 112 is disposed on the first end 72A of the mullion member 72. In this embodiment, the locking mechanism 112 includes upper and lower lock assemblies 114, 116 which are configured to couple to the upper door 34 and the lower door 36, respectively, as shown in FIG. 9B. The upper and lower lock assemblies 114, 116 are substantially similar and are disposed in a mirrored configuration, wherein a locking pin is outwardly extended from the mullion member 72 to engage the doors 34, 36. Specifically, upper lock assembly 114 includes a locking pin 118 coupled to a handle 120 which moves vertically within a slot 122 for moving the locking pin 118 up and down. The locking pin 118 is engaged and locked to the lower portion 34B of the upper door 34 when the locking pin 118 is in a fully up position. Similarly, lower lock assembly 116 includes a locking pin 118 that engages the upper portion 36A of lower door 36 to lock lower door 36 in a coupled position with the mullion member 72. In this way, the upper and lower lock assemblies 114, 116 lock the upper door 34 and lower door 36 in a sealed engagement with the outer sealing surface 74 of the mullion member 72 and provide a unifying feature, wherein the doors 34, 36 open and close together when the user engages one of the doors 34 or 36 individually. In this way, the locking mechanism 112 provides a mechanical coupling between the doors 34, 36 with the mullion member 72 to provide unified movement of the doors 34, 36. It is contemplated that the digital display 106 will identify when the lock assemblies 114, 116 are in the locked condition by illuminating the locked indicia 108. Similarly, when the lock assemblies 114, 116 are in an unlocked condition, the unlocked indicia 110 will illuminate. It is further contemplated that the locking mechanism 112 may be a single locking mechanism which simultaneously couples the mullion member 72 to the upper and lower doors 34, 36. Thus, the upper and lower lock assemblies 114, 116 are exemplary only and may include other mechanical coupling means known in the art for coupling the hinged mullion assembly 70 to the doors 34, 36.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

1. A refrigerator, comprising:
a main body;
first and second doors rotatably mounted to the main body between open and closed positions, wherein the second door is positioned below the first door with a gap disposed therebetween; and
a mullion assembly including a mullion member rotatably mounted to the main body at an independent hinge assembly disposed adjacent to the gap between the first and second doors, wherein the mullion member is operable between open and closed positions and is releasably coupled to a lower edge of the first door and an upper edge of the second door when the first and second doors are in the closed position, and
upper and lower locking assemblies disposed on mullion assembly, wherein each of the upper and lower locking assemblies includes a retractable locking pin for selectively locking the mullion assembly to the first and second doors, respectively.

2. The refrigerator of claim 1, wherein the main body includes a front sealing surface.

3. The refrigerator of claim 2, wherein the mullion member includes an outer sealing surface.

4. The refrigerator of claim 3, wherein the first and second doors include gaskets to seal against the front sealing surface of the main body and the outer sealing surface of the mullion member.

5. The refrigerator of claim 3, wherein the mullion member defines a horizontal divider to a compartment of the refrigerator, and further wherein the first and second doors selectively provide access to the compartment.

6. A refrigerator, comprising:
a main body having at least one compartment with a front sealing surface disposed about a perimeter thereof;
a magnetic member disposed around the front sealing surface;
a first door rotatably mounted to the main body between open and closed positions, the first door including a gasket having a magnetic member disposed therein for coupling to the magnetic member of the front sealing surface;
a second door rotatably mounted to the main body and vertically positioned below the first door, the second door operable between open and closed positions, the second door including a gasket having a magnetic member disposed therein for coupling to the magnetic member of the front sealing surface;
a mullion assembly including a mullion member rotatably mounted to the main body and vertically positioned between the first and second doors, wherein the mullion member is operable between open and closed positions and includes an outer sealing surface;
an electromagnetic member disposed within the mullion assembly and operable between activated and inactivated conditions, wherein the electromagnetic member is configured to couple to the magnetic members of the gaskets of the first and second doors, wherein a magnetic attraction between the electromagnetic member and the magnetic members of the gaskets of the first and second doors is stronger than a magnetic attraction between the magnetic members of the gaskets of the first and second doors and the magnetic member of the sealing surface when the electromagnetic member is in the activated condition.

7. The refrigerator of claim 6, wherein the front sealing surface of the main body includes upper and lower sealing surfaces interconnected by first and second uprights that are spaced-apart from one another.

8. The refrigerator of claim 7, wherein the mullion member is mounted to the second upright via a hinge assembly and divides the compartment in the closed position spanning a distance between the first and second uprights.

9.-11. (canceled)

12. The refrigerator of claim 6, wherein the electromagnetic member provides for unified movement of the first and second doors between the open and closed positions when the electromagnetic member is in the activated condition.

13. The refrigerator of claim 6, wherein the mullion member is moved to the closed position when one of the first and second doors is in the closed position when the electromagnetic member is in the inactivated condition.

14. The refrigerator of claim 13, wherein the mullion member is in the open position when both the first and second doors are in the open position.

15. A refrigerator, comprising:
at least one compartment defined within a main body of the refrigerator;
a first door rotatably mounted to the main body and operable between open and closed positions;
a second door rotatably mounted to the main body and operable between open and closed positions, wherein the second door is vertically positioned below the first door;
a mullion assembly including a mullion member rotatably mounted to the main body and vertically positioned at a gap disposed between the first and second doors, wherein the mullion member is operable between open and closed positions; and
a locking, mechanism disposed between the first and second doors and the mullion member to lock the first and second doors in a sealed position with an outer sealing surface of the mullion member, wherein the first and second doors move in a unified manner between the open and closed positions when the locking mechanism is in a locked condition.

16. The refrigerator of claim 15, wherein the mullion member includes an outer sealing surface, and further wherein the first and second doors releasably couple to the mullion member at the outer sealing surface thereof.

17. The refrigerator of claim 16, wherein the first and second doors include independent swing paths between the open and closed positions.

18. The refrigerator of claim 17, wherein the first door is coupled to the mullion member when the first door is closer to the closed position along the swing path thereof relative to the second door.

19. The refrigerator of claim 17, wherein the second door is coupled to the mullion member when the second door is closer to the closed position along the swing path thereof relative to the first door.

20. (canceled)
